(19) United States
(12) Patent Application Publication
(10) Pub. No.: US 2024/0278238 A1
(43) Pub. Date: Aug. 22, 2024

(54) PLUNGER AND SOLUTION-MOVING MODULE

(71) Applicant: MICO BIOMED CO., LTD., Seongnam-si (KR)

(72) Inventors: Hee Yeong JANG, Seongnam-si (KR); Yong Hee KIM, Seongnam-si (KR); Tae Eun KIM, Seongnam-si (KR)

(21) Appl. No.: 18/651,704

(22) Filed: May 1, 2024

Related U.S. Application Data
(63) Continuation of application No. PCT/KR2022/016791, filed on Oct. 31, 2022.

(30) Foreign Application Priority Data
Nov. 1, 2021 (KR) 10-2021-0147992

(51) Int. Cl. B01L 3/00; B01L 7/00

(52) U.S. Cl. CPC B01L 3/50273; B01L 7/52; B01L 2200/16; B01L 2300/0819; B01L 2300/18; B01L 2400/0487

(57) ABSTRACT

The present invention provides a plunger that is inserted into a syringe to move solution while reciprocating, the plunger comprising a porous sintered polymer filter layer that swells when in contact with solution to block the moving of the solution and air. The solution-moving module using the plunger of the present invention has the effect of moving an elastic fluid such as air out of the syringe, and allowing only solution to move.

### TECHNICAL FIELD

This application claims priority to and the benefit of Korean Patent Application No. 10-2021-0147992, filed on Nov. 1, 2021 in the Korean Intellectual Property Office, the disclosure of which is incorporated herein by reference in its entirety.

The present invention relates to a plunger that is inserted into a syringe and a solution-moving module using the plunger.

### BACKGROUND ART

In the syringe or solution-moving device using the plunger of the related art, a plunger head is sealed and then pressed to eject liquid. Typically, there is a space inside the syringe, and the space is filled with air, and thus air and liquid are present together inside the syringe. In a case where liquid is ejected to the outside of the syringe, a purging action is performed by pressing the plunger until air is ejected.

However, it is not known whether all the air has been discharged before liquid is discharged to the outside of the syringe, and as air is moved together with liquid, air bubbles, namely, bubbles, are generated. This creates uncertainty about the capacity of solution being moved, and causes a problem that the moving speed of liquid is not constant as air bubbles are generated.

Accordingly, it is necessary to avoid or minimize the need to purge unnecessary air within a device that moves liquid using a plunger. Therefore, there is a need to develop a solution-moving device that could remove air from the space within the syringe. Disclosure

### TECHNICAL PROBLEM

The present invention is directed to providing a plunger that is inserted into a syringe to move liquid.

Further, the present invention is directed to providing a solution-moving module including the plunger.

Further, the present invention is directed to providing an integrated chip including the solution-moving module.

Further, the present invention is directed to providing a lysis module including the integrated chip.

Further, the present invention is directed to providing an on-site diagnostic device including the lysis module.

### TECHNICAL SOLUTION

One aspect of the present invention provides a plunger that is inserted into a syringe and moves liquid while reciprocating, the plunger including a porous sintered polymer filter layer configured to swell upon contact with a solution to block movements of the solution and air.

In one aspect of the present invention, the plunger may move the air up and down within the syringe as the plunger moves downward.

In one aspect of the present invention, when the polymer filter layer comes into contact with the solution in the syringe, the plunger may push the liquid to an outlet of the syringe as the plunger moves.

In one aspect of the present invention, the polymer filter layer may be located on a passage that passes vertically through an inside of the plunger.

In one aspect of the present invention, the polymer may include one or more selected from the group consisting of ultra-high molecular weight polyethylene (UHMW-PE), hydroxypropylmethylcellulose, hydroxyethylmethylcellulose, hydroxypropylcellulose, hydroxymethylcellulose, hydroxyethylcellulose, carboxymethylcellulose, calcium carboxymethylcellulose, sodium carboxymethylcellulose, methylcellulose, ethylcellulose, polyethylene oxide, locust bean gum, guar gum, xanthan gum, acacia gum, tragacanth gum, alginic acid, sodium alginate, calcium alginate, ammonium alginate, agar, gelatin, poloxamer, poly(methyl methacrylate), carbomer, polycarbophil, polyvinylpyrrolidone, polyvinyl acetate, polyethylene glycol, polyvinylpyrrolidone-polyvinyl acrylate copolymer, polyvinyl alcohol-polyethylene glycol copolymer, polyvinylpyrrolidone-polyvinyl acetate copolymer, bentonite, hectorite, carrageenan, ceratonia, cetostearyl alcohol, chitosan, hydroxypropyl starch, magnesium aluminum silicate, polydextrose, poly(methyl vinyl ether/maleic anhydride), propylene glycol alginate, saponite, and polycarbophil.

In one aspect of the present invention, the polymer may be a bead with a diameter of 10 μm to 800 μm.

In one aspect of the present invention, the plunger may further include a porous barrier filter layer in contact with one surface or the other surface of at least one layer of the polymer filter layer.

In one aspect of the present invention, the barrier filter layer may include polyethylene.

One aspect of the present invention provides a solution-moving module including: the plunger; and a syringe into which the plunger is inserted.

In one aspect of the present invention, the solution-moving module may further include a pushing portion configured to come into contact with at least one portion of the plunger to move the plunger.

In one aspect of the present invention, the pushing portion may extend in a direction perpendicular to an end portion of the plunger.

In one aspect of the present invention, an upper portion of the plunger may have a shape including convex portions and concave portions such that an end portion of the pushing portion comes into contact with the convex portions of the plunger.

In one aspect of the present invention, the pushing portion may include a protrusion configured to come into contact with at least a part of a surface of the plunger at a lower portion thereof and include a passage through which air passes at a side portion thereof.

In one aspect of the present invention, the plunger may include a packing member in contact with an inner wall of the syringe.

In one aspect of the present invention, the syringe may include a hydrophobic membrane located below a region containing the liquid.

In one aspect of the present invention, the membrane may include one or more of a filter portion and a porous support portion, and the liquid may pass through the membrane when pressure is applied.

In one aspect of the present invention, the plunger may have a tapered shape with a cross-sectional diameter that decreases toward a bottom thereof.

In one aspect of the present invention, the syringe may further include a plunger support portion located above the membrane, and the plunger support portion may have a shape that is to be combined with the plunger when the plunger moves to the bottom of the syringe.

In one aspect of the present invention, the syringe may further include a membrane support portion located below the membrane and having a flow path for the liquid.

In one aspect of the present invention, the plunger support portion may include a packing member in contact with an inner wall of the syringe.

One aspect of the present invention provides an integrated chip including the solution-moving module.

In one aspect of the present invention, the integrated chip includes: a polymerase chain reaction (PCR) chip including an inlet, an outlet, and a reaction channel; one or more insertion portions which extend in a longitudinal direction of the reaction channel on one side of the PCR chip and to which the syringe with an open upper end is detachably attached;

a cover portion including a cover plate for opening or closing the upper end of the syringe and a pair of support plates connected to both ends of the cover plate; and a valve portion which is disposed between the insertion portion and the PCR chip, adjusts opening or closing of the reaction channel, and seals the inlet of the reaction channel during a PCR, wherein a sample solution is sequentially moved to the PCR chip after being lysed in the syringe.

In one aspect of the present invention, in the integrated chip, a cap made of a soft material for sealing the upper end of the syringe may be inserted into the cover portion to seal the upper end of the syringe, and the integrated chip may further include a pressing protrusion configured to press the cap downward such that the sample solution is moved to the PCR chip by pressure after being lysed.

In one aspect of the present invention, the insertion portion may further include a coupling portion to which the syringe is fit and coupled; and a receiving portion in which the sample solution may remain for a certain period of time before being moved to the PCR chip after being lysed.

One aspect of the present invention provides a lysis module including the integrated chip.

In one aspect of the present invention, the lysis module includes: the integrated chip; a plurality of heat transfer elements spaced apart from each other to face each other and configured to transfer heat to the syringe; a fixing portion on which the integrated chip is mounted and which fixes the cover portion in a state in which the syringe is sealed; and a driving rail configured to move the fixing portion such that the syringe receives the heat and configured to guide a movement of the fixing portion, wherein the sample solution injected into the syringe may be lysed by the heat of the heat transfer elements.

One aspect of the present invention provides an on-site diagnostic device including the lysis module.

In one aspect of the present invention, the on-site diagnostic device includes: the lysis module; and a PCR module in which a PCR is performed, wherein the lysis and the PCR may be successively performed.

### ADVANTAGEOUS EFFECTS

A plunger according to one embodiment of the present invention has an advantage that air can selectively pass through the plunger.

A solution-moving module using the plunger according to one embodiment of the present invention has an effect of moving only a solution without moving air. Thus, there is an effect of removing air inside a syringe. Additionally, since only the solution is moved, there is an advantage of eliminating the delay in reaction time that occurs when the solution and air are moved together.

In addition, since a constant flow rate is maintained when the solution is moved, it is possible to stably operate the solution-moving module and there is an advantage that the problem of bubble generation is solved. In addition, since the stability of flow is ensured even at a high flow rate, there is an effect of shortening the fluid transfer time.

An integrated chip including a syringe including a plunger of the present invention and a polymerase chain reaction (PCR) chip has an advantage that processes of lysis, nucleic acid extraction, and nucleic acid amplification of a sample solution are performed on a single platform and thus the processes can be performed simply and quickly.

### BRIEF DESCRIPTION OF DRAWINGS

FIGS. 1A-1B are perspective views of a plunger according to an embodiment of the present invention.

FIG. 2 is a perspective view of an upper portion of a plunger according to the embodiment of the present invention.

FIG. 3 is a cross-sectional view of a solution-moving module according to an embodiment of the present invention.

FIG. 4A is a cross-sectional view of a solution-moving module before a lower portion of a plunger comes into contact with a solution in a syringe in an embodiment of the present invention, and FIG. 4B is a cross-sectional view of the solution-moving module in which the plunger moves the liquid in the syringe downward.

FIG. 5 is a cross-sectional view of an integrated chip according to an embodiment of the present invention.

FIG. 6 is an overall perspective view of a device according to an embodiment of the present invention.

FIG. 7 is a cross-sectional view of the device according to the embodiment of the present invention as seen from above.

FIG. 8A is a perspective view of a lysis module equipped with an integrated chip according to an embodiment of the present invention, and FIG. 8B is a perspective view of the lysis module from which the integrated chip separated.

FIG. 9 is a perspective view of a polymerase chain reaction (PCR) module according to an embodiment of the present invention.

### Modes of the Invention

Hereinafter, the present application will be described in further detail.

Specific function descriptions below are merely exemplified to explain embodiments according to the concept of the present application, and embodiments according to the concept of the present application may be implemented in various forms and should not be construed as being limited to the embodiments described herein.

The present application can be modified and implemented in various forms, and therefore, specific embodiments will be described in detail. However, it should be construed that the present application is not limited to specific disclosed forms, and it should be understood that the present application includes all modifications, equivalents and alternatives included in the spirit and scope of the present application.

The terms used in the specification are used only to describe specific examples, not to limit the present application. Singular expressions include plural expressions unless clearly indicated otherwise in the context.

Unless defined otherwise, all terms including technical and scientific terms have the same meanings that are generally understood by those skilled in the art. General terms, such as terms defined in dictionaries, should be interpreted with meanings according to the context of related technology, and should not be interpreted with ideal or excessively formal meanings unless clearly defined herein.

Hereinafter, preferred embodiments of a plunger according to the present invention, a syringe including the same, a solution-moving module including the same, an integrated chip capable of lysis and nucleic acid amplification including the same, a lysis module using a heater, and an on-site diagnostic device including the same will be described in detail with reference to the attached drawings.

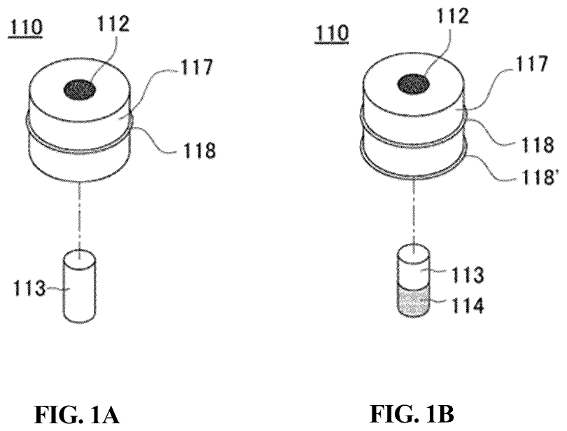

FIGS. 1A-1B are perspective views of a plunger (110) according to one embodiment of the present invention.

The plunger (110) is inserted into a syringe (120) to move a solution 148 while reciprocating and has an insertion hole (112) into which a filter layer may be inserted. A plunger body (117) may include plunger packing members (118) and (118′). Referring to FIG. 1A, a porous sintered polymer filter layer (113) may be inserted into the insertion hole (112), and referring to FIG. 1B, a filter layer including the porous sintered polymer filter layer (113) and a porous barrier filter layer (114) may be inserted into the insertion hole (112).

The filter layer may include the polymer filter layer (113) alone or further include the porous barrier filter layer (114) in contact with one surface or the other surface of at least one layer of the polymer filter layer (113). The filter layer may include the porous barrier filter layer (114) on the lower surface of the polymer filter layer (113) and include the porous barrier filter layers (114) on both the upper surface and the lower surface of the polymer filter layer (113).

The porous sintered polymer layer (113) may include porous sintered polymer beads or an aggregate of porous sintered polymer beads. The diameter of the bead may be in the range of 10 μm to 800 μm, and the diameter of the bead aggregate may be 5 mm or less. The diameter of the polymer bead and the diameter of the bead aggregate are not limited to the present description.

The porous sintered polymer (113) is a sintered water-swelling polymer and has air permeability. The moment the porous sintered polymer comes into contact with moisture, pores expand to prevent fluid from leaking to the outside. The water-swelling polymer may swell upon contact with water to form a gel layer.

The swelling refers to a phenomenon in which a polymer compound absorbs a solvent and increases in volume. The sintering refers to a process in which powder particles become a single lump through a thermal activation process. The sintering is a phenomenon in which, when powder or a lump of compressed powder is heated to a temperature below a melting point, the powder melts and adheres to each other and solidifies and is generally applied to the manufacture of ceramics or small plastics. The water-swelling polymer is a polymer that exhibits a fluid absorption phenomenon due to the introduction of hydrophilic groups in a three-dimensional network structure or single chain structure through cross-linking between polymer chains, may contain fluid at least 15 times the weight of the polymer itself, may support a sufficient amount of fluid under load, and may contain an aqueous solution but is insoluble in the aqueous solution. Additionally, the water-swelling polymer has the property of instantly swelling and gelling when placed in water.

The porous sintered polymer (113) may be made of one or more selected from the group consisting of ultra-high molecular weight polyethylene (UHMW-PE), hydroxypropylmethylcellulose, hydroxyethylmethylcellulose, hydroxypropylcellulose, hydroxymethylcellulose, hydroxyethylcellulose, carboxymethylcellulose, calcium carboxymethylcellulose, sodium carboxymethylcellulose, methylcellulose, ethylcellulose, polyethylene oxide, locust bean gum, guar gum, xanthan gum, acacia gum, tragacanth gum, alginic acid, sodium alginate, calcium alginate, ammonium alginate, agar, gelatin, poloxamer, poly(methyl methacrylate), carbomer, polycarbophil, polyvinylpyrrolidone, polyvinyl acetate, polyethylene glycol, a polyvinylpyrrolidone-polyvinyl acrylate copolymer, a polyvinyl alcohol-polyethylene glycol copolymer, a polyvinylpyrrolidone-polyvinyl acetate copolymer, bentonite, hectorite, carrageenan, ceratonia, cetostearyl alcohol, chitosan, hydroxypropyl starch, magnesium aluminum silicate, polydextrose, poly(methyl vinyl ether/maleic anhydride), propylene glycol alginate, saponite, and polycarbophil.

The barrier layer (114) may be a pipette tip filter layer, and any layer that blocks the movement of nucleic acids may be applied as the barrier layer (114). For example, the barrier layer (114) may be made of a material containing polyethylene.

The filter layer may be positioned on a passage that passes vertically through the inside of the plunger (110), and thus air may move inside the filter layer as the plunger (110) moves vertically.

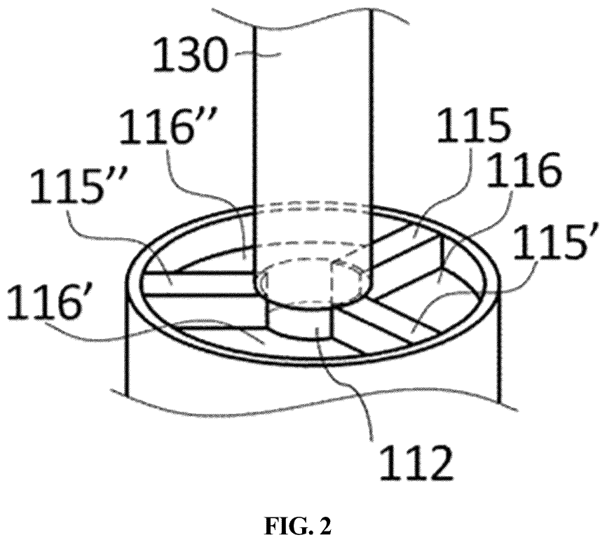

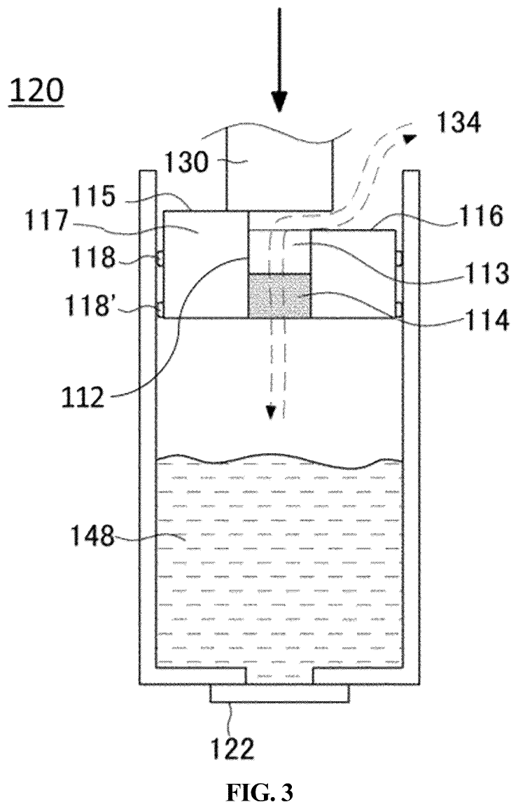

FIG. 2 shows an upper portion of the plunger (110) and a pushing portion (130) in contact with each other when the pushing portion moves the plunger (110) in one embodiment of the present invention, and FIG. 3 shows a cross-sectional view of a solution-moving module according to one embodiment of the present invention.

The solution-moving module may include the plunger (110) and a syringe (120) into which the plunger (110) is inserted.

Referring to FIGS. 2 and 3, the pushing portion (130) may come into contact with at least one portion of the plunger (110) at the upper portion of the plunger (110) to move the plunger (110). The pushing portion (130) may extend in a direction perpendicular to an end portion of the plunger (110). The upper portion of the plunger (110) has a shape including convex portions (115, 115′, and 115″) and concave portions (116, 116′, and 116″) such that an end portion of the pushing portion comes into contact with the convex portions (115, 115′, and 115″) of the plunger (110). At this time, the concave portions (116, 116′, and 116″) located between the convex portions (115, 115′, and 115″) of the plurality of plungers (110) are not in contact with the pushing portion (130), thereby allowing air to pass therethrough. While the pushing portion presses and moves the plunger (110), an air passage (134) that passes through the filter layer in the plunger (110) may be formed. An air layer inside the syringe may be moved through the air passage (134) until a lower portion of the plunger (110) comes into contact with the solution. The plunger (110) of the present invention has an advantage that an elastic fluid such as air can be moved to the outside of the syringe and only an inelastic fluid such as a solution can be moved. Therefore, the solution-moving module including the plunger (110) has an advantage that a problem of delayed reaction time can be solved compared to a plunger (110) of the related art which moves air and liquid together and the reaction time can be precisely and accurately adjusted.

Therefore, there is an advantage that the amount of solution can be quantified at a constant amount and the flow rate of solution movement can be adjusted constant. In addition, since a constant flow rate is maintained when the solution is moved, it is possible to stably operate the solution-moving module. In addition, since the flow rate of the solution can be controlled to be constant, there is an advantage that the problem of bubble generation is solved by eliminating or minimizing the generation of bubbles. In addition, since the stability of flow is ensured even at a high flow rate, there is an effect of shortening the fluid transfer time.

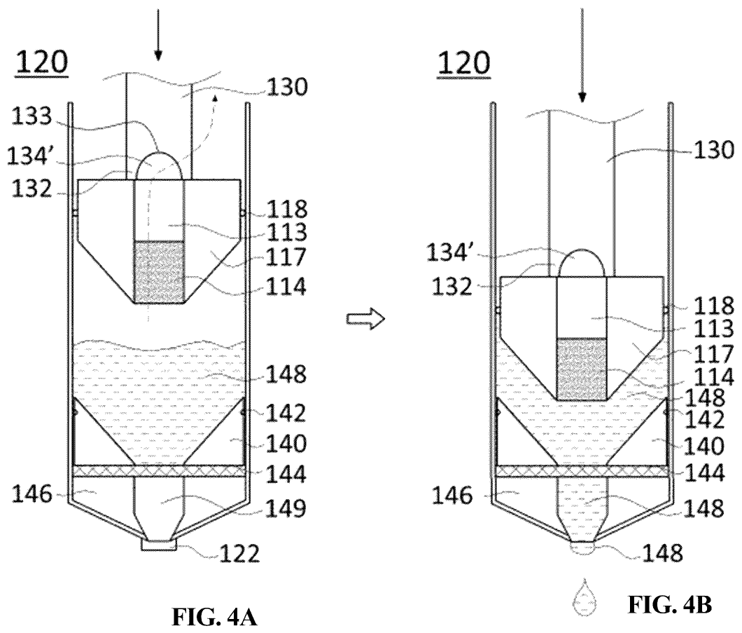

FIGS. 4A-4B show a solution-moving module according to another embodiment of the present invention. FIG. 4A is a cross-sectional view of a solution-moving module before a lower portion of a plunger comes into contact with a solution in a syringe in one embodiment of the present invention, and FIG. 4B is a cross-sectional view of the solution-moving module in which the plunger moves the liquid in the syringe downward.

Referring to FIGS. 4A-4B, the lower portion of the pushing portion (130) is provided with a protrusion (132) and a concave portion (133), and thus air may move through the concave portion (133). The protrusion may come into contact with at least a part of the surface of the plunger (110) and may include a concave portion (133) such that a passage (134′) through which air passes is formed at a side portion of the lower portion of the pushing portion (130). At this time, the pushing portion (130) presses the plunger (110) and the plunger (110) moves in the syringe, allowing air to pass through the filter layer. Referring to FIG. 4A, when the plunger moves downward in a state in which the porous sintered polymer filter layer (113) of the filter layers is not in contact with the liquid, the air is moved upward in a direction opposite to a moving direction of the plunger, and the solution (liquid) is not moved. Referring to FIG. 4B, discharge of the liquid does not occur simultaneously with the downward movement of the plunger, and the liquid may be discharged from the time point when the filter layer comes into contact with the solution after the movement of the plunger. As the plunger (110) moves in the syringe (120), the porous sintered polymer filter layer (113) of the filter layers swells at the moment when the porous sintered polymer filter layer (113) comes into contact with the liquid, and thus an internal porous structure is blocked, the movement of air is blocked, and the solution (148) is moved by the plunger (110). In addition, at the same time, the solution is also prevented from passing through the filter layer, and thus the solution (148) may be pushed in the direction in which the plunger moves.

The plunger (110) includes the syringe packing members (118 and 118′) in contact with the inner wall of the syringe (120) to control the moving speed of the plunger (110) and prevent air from moving on the outer peripheral surface of the plunger (110).

The syringe (120) may include a hydrophobic membrane (144) located below a region containing the solution (148), and the membrane (144) may include one or more of a filter portion (144′) and a porous support portion (144″). The membrane (144) may be formed of only the filter portion (144′) through which the solution (148) may pass or formed of two or more layers that include the filter portion (144′) and the porous support portion (144″) supporting the filter portion (144′). The solution (148) containing particles with a desired size may be moved to the bottom of the syringe through the membrane (144).

Referring to FIGS. 4A-4B, the plunger (110) may have a tapered shape with a cross-sectional diameter that decreases toward the bottom thereof and may include a plunger support portion (140) located above the membrane (144) and having a shape capable of being combined with the plunger (110). When the plunger (110) moves to the bottom of the syringe (120), the plunger (110) and the plunger support portion are coupled to effectively move the solution (148) to a portion below the membrane (144) in a desired amount. The plunger support portion may include a plunger support portion packing member (142) in contact with the inner wall of the syringe (120) so that plunger support portion may be fixed within the syringe (120).

The syringe (120) may include a membrane support portion (146) that serves to support the membrane (144). The membrane support portion (146) includes a flow path for the solution (148) therein, and thus the solution (148) that has passed through the membrane may move through the membrane support portion (146). The solution (148) that has moved through the membrane support portion (146) may move to the bottom of the syringe when a cover (122) on the bottom of the syringe is removed.

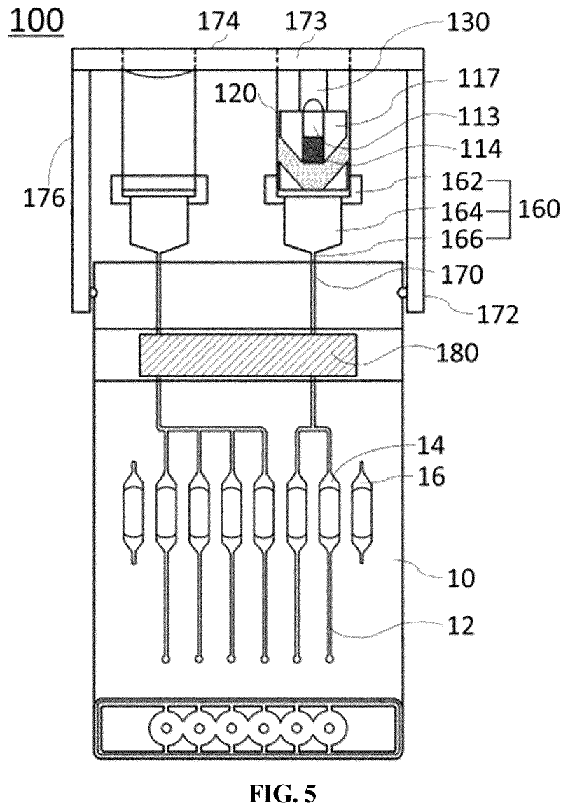

FIG. 5 is a cross-sectional view of an integrated chip according to one embodiment of the present invention.

Referring to FIG. 5, the integrated chip (100) includes a polymerase chain reaction (PCR) chip (10) including an inlet, an outlet, and a reaction channel, an insertion portion (160) which extends in a longitudinal direction of the reaction channel on one side of the PCR chip (10) and to which the syringe (120) with an open upper end is detachably attached, a cover portion (172) of which both ends are hinge-coupled to both sides of the insertion portion (160) to open or close the upper end of the syringe (120), and a valve portion (180) disposed between the insertion portion (160) and the PCR chip (10), and a sample solution is lysed in the syringe (120) and then sequentially moves to the PCR chip. That is, the integrated chip (100) performs a lysis process on the injected sample solution through a lysis buffer, and after the lysis process, nucleic acid amplification is possible by distributing the lysed sample solution to the PCR chip (10).

The sample solution may be a sample containing nucleic acid molecules, and the sample containing nucleic acid molecules may be blood, serum, plasma, urine, sweat, tears, tissue, or cells. Additionally, the lysis buffer may be a buffer solution, but may also be distilled water or a PCR solution.

Referring to FIG. 5, a microchip capable of controlling the movement of fluid is provided and includes an inlet into which fluid flows, a reaction channel in which a predetermined reaction is performed on the inflow fluid, and an outlet through which fluid flows out of the reaction channel.

In the present invention, the lysis process and the PCR are performed in one integrated chip, eliminating the need for separate equipment and shortening the process time.

In a microchip, the fluid flowing in through the inlet is subjected to a predetermined reaction in a reaction region and may then flow out through the outlet. Here, the reaction in the microchip may be PCR (nucleic acid amplification). However, this is an example, and various reactions may be performed depending on embodiments to which the present invention is applied.

In one embodiment of the present invention, the microchip may be the PCR chip (10). The PCR chip (10) may include an inlet through which the sample solution is injected, a reaction channel (or a chamber) in which a nucleic acid amplification reaction of the sample solution is performed, and an outlet through which the sample solution that has completed the nucleic acid amplification reaction is discharged.

The PCR chip (10) may include a first plate having a flat shape, a second plate disposed vertically above the first plate to form a reaction channel, and a third plate spaced apart from the first plate, disposed above the second plate, and having an inlet and an outlet formed to pass through a substrate.

In another embodiment of the present invention, the PCR chip (10) may include a lower plate recessed in a surface of a flat substrate to form a reaction channel and an upper plate disposed above and having an inlet and an outlet formed to pass through the substrate.

The first plate or the lower plate is implemented in a flat shape and may serve as a bottom support for the PCR chip (10) according to one embodiment of the present invention.

The second plate is disposed above the first plate and may serve to form a reaction channel of the PCR chip (10) according to one embodiment of the present invention.

The third plate may be disposed above the second plate or the upper plate may be disposed above the lower plate to serve as a cover covering the reaction channel of the PCR chip (10).

The PCR chip (10) may come into contact with one surface of each of first heat blocks (310 and 310′) or each of second heat blocks (330 and 330′) and may contain the sample solution containing a nucleic acid, for example, double-stranded DNA, an oligonucleotide primer having a sequence complementary to a specific base sequence to be amplified, DNA polymerase, deoxyribonucleotide triphosphates (dNTP), and a PCR buffer. When the PCR chip (10) comes into contact with the first heat blocks (310 and 310′) or the second heat blocks (330 and 330′), the heat of the first heat blocks (310 and 310′) or the second heat blocks (330 and 330′) is transferred to the PCR chip (10), and the sample solution contained in the reaction channel (or chamber) of the PCR chip (10) may be heated, and the temperature thereof may be maintained. Additionally, the PCR chip (10) may have an overall planar shape, but is not limited thereto. In addition, the outer wall of the PCR chip (10) may have a shape and structure for being fixedly mounted in the inner space of a fixing portion (230) such that the PCR chip (10) is not separated from the fixing portion (230) when a nucleic acid amplification reaction is performed.

Referring to FIG. 5, the reaction channel (12) may include a reaction region (14) positioned therein to be spaced apart from the outlet. When the number of reaction channels (12) is one or more, two or more, or four to six, the number of reaction regions (14) may be one or more, two or more, or four to six to correspond thereto.

In one embodiment of the present invention, the PCR chip (10) may further include a dummy region (16). A plurality of dummy regions (16) may be provided, and a plurality of reaction regions may be disposed side by side between the plurality of dummy regions (16).

Since the reaction regions (14) are disposed side by side between the dummy regions (16), there is an advantage that the heat of the reaction regions (14) is uniformly adjusted. For example, when four to six reaction regions (14) are disposed side by side, there is a problem that the temperature of the two reaction regions (14) disposed on both sides may be lower than that of the reaction region (14) located in the center. Since the

PCR chip may be formed of a plastic material, the temperature of the two reaction regions (14) disposed on both sides may be lower than that of the reaction region (14) located in the center due to poor heat transfer due to heating of the surrounding plastic. Therefore, there is a problem that the efficiency of the PCR can be hindered compared to the reaction region (14) located in the center. Therefore, the dummy regions (16) located on the sides of the two reaction regions (14) disposed on both sides prevent the temperature of the reaction regions (14) located at the edges from falling, and thus there is an effect that a uniform temperature can be maintained in all the reaction regions (14).

According to one embodiment of the present invention, the syringe (120) may have a tube shape with the open upper and lower ends, and the sample solution and the lysis buffer may be injected thereinto. The syringe (120) only has to include an opening through which the sample solution and the lysis buffer may be injected or flowed out, and the shape of the syringe (120) is not necessarily limited to the tubular shape.

In one embodiment of the present invention, a heat transfer element (210) that transfers heat to the syringe (120) may be a halogen heater. This allows heat transfer through radiation. Therefore, since a non-contact heat transfer method is used, the external shape of the syringe (120) is not affected by the heat transfer element (210) and may be formed in various ways.

The lysis process may be performed in the syringe (120). As will be described below, the syringe (120) is detachably fitted and coupled to the insertion portion (160) of the integrated chip (100). The integrated chip (100) is mounted on a fixing frame of a lysis module (200) and positioned between a plurality of heat transfer elements (210) by a first driving rail (270). In this case, the lysis process may be performed at about 90° C. to 95° C.

In one embodiment of the present invention, the syringe (120) may include the membrane (144) at the lower end thereof for filtering the sample solution. The membrane (144) has a plurality of pores. The pores may have a diameter of 3 to 300 nm, 10 to 280 nm, 25 to 270 nm, 50 to 250 nm, or 100 to 220 nm. The thickness of the membrane (144) may be in the range of 10 nm to 5 μm. However, it is not necessarily limited to this. The material of the membrane (144) may be a semiconductor, a metal, a metal nitride, a semiconductor nitride, a metal sulfide, a semiconductor sulfide, a metal phosphide, a semiconductor phosphide, a metal arsenide, a semiconductor arsenide, a metal oxide, or a semiconductor oxide, and any material of which a thin film with a certain thickness may be formed through a thin film formation method such as a chemical vapor deposition (CVD) or physical vapor deposition (PVD) method may be used as the material of the membrane (144).

In one embodiment of the present invention, after the lysis process is performed in the syringe (120), the sample solution may pass through the membrane (144) and move to a receiving portion (164) provided in the insertion portion (160). In one embodiment of the present invention, the syringe (120) may include a layer coated with black paint therein. In order to prevent radiant heat generated by the heat transfer element (210) from being reflected at an absorption portion of the syringe (120), an implant, a sheet, or the like may be coated with black paint with excellent radiant heat absorption.

The implant, the sheet, or the like may be a material with high thermal conductivity, for example, a metal member made of aluminum or stainless steel. The shape of the black-coated layer may vary depending on the shape of the syringe (120) and may be disposed in a longitudinal direction of the syringe (120). For example, in the case of a cylindrical syringe (120), a cylindrical layer coated with black paint may be provided in the syringe (120).

The black-coated layer can increase heat transfer efficiency by radiation and shorten the lysis time.

In one embodiment of the present invention, the integrated chip (100) may include the insertion portion (160) to which the syringe (120) may be detachably attached. The insertion portion (160) may be formed integrally with the PCR chip (10) by being disposed on one side of the PCR chip (10) to extend in the longitudinal direction of the reaction channel. Additionally, the insertion portions (160) may be provided to correspond to the number of syringes (120), and in this case, a plurality of insertion portions (160) may be spaced apart from each other.

By inserting the syringe (120) into the insertion portion (160), the sample solution may be sequentially moved to the PCR chip after the lysis process in the syringe (120), thereby enabling the PCR. After the lysis process is performed, the sample solution may be moved directly to the PCR chip (10) to proceed with the PCR without the need to separately move the sample solution to the PCR chip and the PCR device.

In one embodiment of the present invention, the insertion portion (160) may include a coupling portion (162) to which the syringe (120) is fitted and coupled, the receiving portion (164) in which the sample solution may remain for a certain period of time before being moved to the PCR chip (10) after being lysed, and an outlet portion (166) that allows the sample solution to exit and move to the PCR chip. The coupling portion (162) is located on an upper side of the receiving portion (164), and the sample solution may pass through the membrane (144) at the lower end of the syringe (120) and may be stored in the receiving portion (164) for a certain period of time.

In one embodiment of the present invention, the coupling portion (162) may be coupled to the lower end of the syringe (120). A plurality of coupling protrusions may be provided on an outer peripheral surface of a lower end portion of the syringe (120), and the coupling portion (162) may include coupling grooves to which the plurality of coupling protrusions of the lower end portion of the syringe (120) may be fitted, wherein the number of coupling grooves corresponds to the number of coupling protrusions. Additionally, the coupling portion (162) may be formed to have a diameter slightly larger than the diameter of the syringe (120) such that the syringe (120) may be inserted into the coupling portion (162), and has the same shape as the plane of the syringe (120). For example, when the coupling protrusions have the shape of two flat plates and are spaced apart from each other at regular intervals at the lower end portion of the outer peripheral surface of the syringe (120), the coupling grooves may also have the shape of six flat plates and may be spaced apart from each other at regular intervals. The syringe (120) may be inserted into the coupling portion (162) by downward pressing and then rotated to engage the coupling protrusions and the coupling grooves, thereby fixing the syringe (120) to the insertion portion (160). Additionally, the syringe (120) may be doubly inserted into the insertion portion (160) and fixed thereto. That is, the lower end portion of the syringe (120) may be coupled to the coupling portion (162), and the upper end portion of the syringe (120) may be supported by the cover portion (172), which will be described below.

The coupling may be hinge-coupling or fitting-coupling, and the form of the coupling is not limited as long as the syringe (120) can be detachably attached to the coupling groove.

In one embodiment of the present invention, the insertion portion (160) may further include the receiving portion (164). The receiving portion (164) may be provided on the lower side of the coupling portion (162). The form of the receiving portion (164) is sufficient as long as the receiving portion (164) includes a space in which the lysed sample solution can be accommodated, and the form of the receiving portion (164) is not limited.

After the lysis process of the sample solution proceeds in the syringe (120) coupled to the coupling portion (162), the sample solution may remain in the receiving portion (164). The lysed sample solution is not immediately transferred to the PCR chip but may remain in the receiving portion (164) for a certain period of time, allowing the movement of the sample solution to be controlled. Additionally, the receiving portion (164) may include the membrane (144) described above. The membrane (144) of the receiving portion (164) may serve to filter the sample solution.

In one embodiment of the present invention, the receiving portion (164) may include the outlet portion (166), and the outlet portion (166) may be connected to a flow path (170) leading to the valve portion 180, which will be described below. The sample solution that has passed through the membrane (144) of the receiving portion (164) exits through the outlet portion (166) and moves to the valve portion (180) through the flow path (170). Inside the integrated chip (100), the sample solution passes through the outlet portion (166) of the receiving portion (164), moves along the flow path (170) to the valve portion (180), and then moves to the PCR chip (10).

In one embodiment of the present invention, the integrated chip (100) may include a cover portion (172) which includes a cover plate (174) that opens or closes the upper end of the syringe (120) and a pair of support plates (176) connected to both ends of the cover plate (174), wherein the support plate (176) is hinge-coupled to the integrated chip (100). The support plates (176) may be hinge-coupled to both upper sides of the valve portion (180). The support plates (176) may be hinge-coupled to both sides of the integrated chip (100) or the upper sides of the valve portion (180) to adjust a rotation angle. The overall shape of the cover portion (172) may be arched, ∩-shaped, or Π-shaped. However, the cover portion (172) of the present invention is sufficient as long as the cover portion (172) can cover the upper end of the syringe (120) coupled to the insertion portion (160), and its shape is not limited.

After the syringe (120) is coupled to the insertion portion (160), the upper end of the syringe (120) may be covered by rotating or moving the cover portion (172) toward the upper end of the syringe (120) through the hinge.

The cover portion (172) may serve to support the upper end of the syringe (120).

In addition, in order for the lysis process to be performed, since the upper end of the syringe (120) has to be sealed by the cover portion (172), the outer wall of the cover portion (172), which will be described below, may have a structure and a shape that may be in fixed contact with the inner wall of the fixing portion (230) without shaking.

In one embodiment of the present invention, the cover portion (172) may include a cap (173). The cap (173) of the present invention is inserted into a groove of the cover plate (174) of the cover portion (172) with the open upper and lower surfaces and is provided at the same position as the upper end surface of the syringe (120) when the cover portion (172) covers the upper end of the syringe (120). In addition, since the cap (173) is pressed downward by a pressing protrusion (250), which will be described below, and pushed into the syringe (120), it is preferable that the cap (173) be inserted into the groove with both the open upper and lower surfaces. The pressing protrusion (250) may push the cap (173) toward the inside of the syringe (120) to move the pushing portion (130), thereby applying pressure to the inside of the syringe (120). After the lysis process, the sample solution may be moved to the PCR chip (10) by pressure.

The cap (173) may be made of any soft material with excellent flexibility and elasticity, as well as urethane-based rubber.

In one embodiment of the present invention, the integrated chip may be an integrated chip including a valve portion (180) provided between the PCR chip (10) and the insertion portion (160). However, it is sufficient as long as the valve portion can control the flow and flow rate of the fluid when the sample solution moves to the PCR chip (10) after the lysis process of the sample solution, and the form of the valve portion (180) is not limited.

In one embodiment of the present invention, one side of the valve portion (180) may be connected to the flow path (170) of the insertion portion (160), the other side thereof may be connected to the reaction channel of the PCR chip (10), and the valve portion (180) may adjust the opening or closing of the flow path (170) by sliding in a vertical or horizontal direction. For example, when a first valve horizontally moves a certain distance in one direction, all of the flow paths (170) are opened to allow the fluid to flow in or out of the inlet of the PCR chip, and when the valve horizontally moves a certain distance again, all of the flow paths (170) are closed to prevent the fluid from flowing in or out of the PCR chip. Additionally, the valve portion 180 may adjust the opening or closing of the reaction channel by sliding.

In one embodiment of the present invention, since the valve portion is connected to the reaction channel of the PCR chip (10), when the valve moves a certain distance, the inlet of the reaction channel can be sealed and external leakage of the fluid can be prevented.

Therefore, the inlet of the PCR chip can be sealed simply by sliding the valve portion (180), and thus no separate equipment for sealing is required, space utilization is improved, and the effort and time to seal the inlet are reduced.

In one embodiment of the present invention, as the valve portion (180) is disposed between the insertion portion (160) on which the syringe (120) is mounted and the PCR chip (10), the syringe (120) in which the lysis process is performed and the PCR chip (10) in which the nucleic acid amplification process is performed can be spatially separated, the flow of the fluid from the syringe (120) to the PCR chip (10) through the flow path (170) can be finely adjusted, and the inlet can be sealed when the nucleic acid amplification reaction is performed in the PCR chip (10).

The integrated chip (100) has a structure suitable for performing both the lysis process and the nucleic acid amplification process of the sample solution in one device. Hereinafter, a nucleic acid processing device will be described in detail.

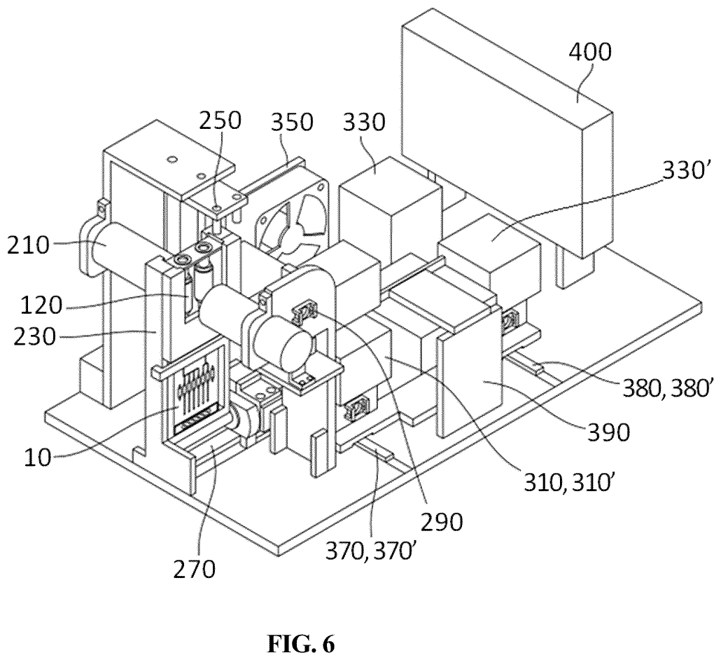

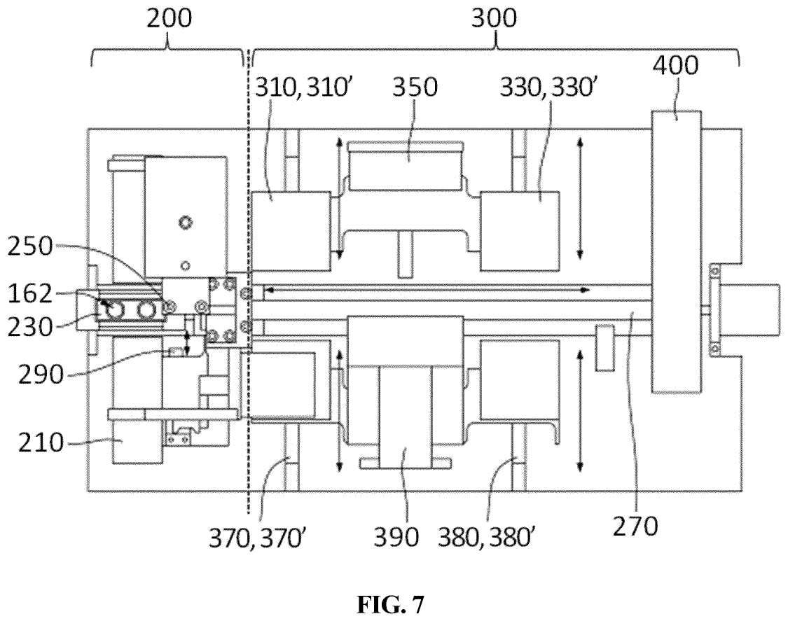

FIG. 6 is an overall perspective view of an on-site diagnostic device according to an embodiment of the present invention, and FIG. 7 is a cross-sectional view of the device according to the embodiment of the present invention as seen from above.

In the present invention, since the lysis process that occurs within the syringe and the PCR are performed in one device rather than in separate devices, the process from nucleic acid extraction to nucleic acid amplification can proceed quickly and efficiently, and on-site diagnosis is possible.

In one embodiment of the present invention, the on-site diagnostic device may include the lysis module described above and a PCR module (300) in which the PCR is performed. Additionally, the lysis and PCR may be successively performed. Since the on-site diagnostic device of the present invention may successively perform the lysis process and the nucleic acid extraction process, which are parts of a pretreatment step, all processes for processing nucleic acids may be performed in one device. In the related art, the equipment for the pretreatment process and the equipment for the PCR were separately provided, and both purification and washing steps had to be performed during the pretreatment process, and thus there was a problem with the time and cost of nucleic acid processing.

The on-site diagnostic device of the present invention has an advantage that the process may proceed directly to the nucleic acid extraction process after the sample solution is lysed in the lysis module (200) without going through separate purification and washing steps, thereby significantly reducing the time and cost of nucleic acid processing.

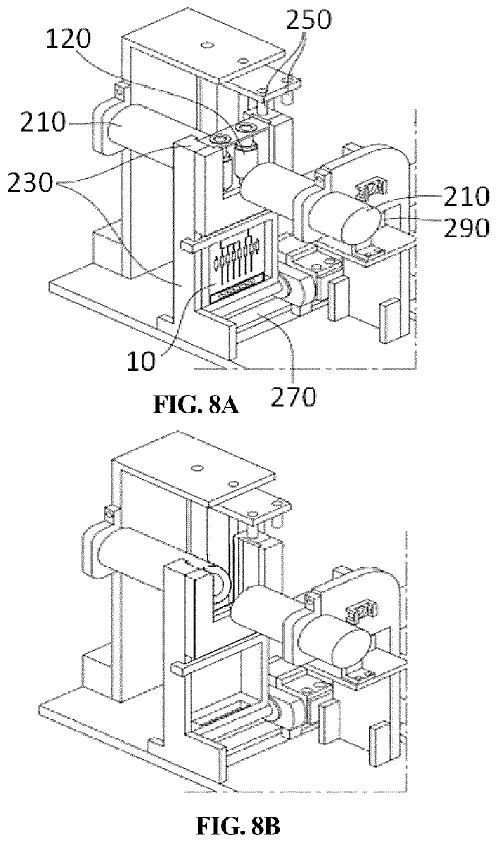

FIG. 8A is a perspective view of a lysis module equipped with an integrated chip according to an embodiment of the present invention, and FIG. 8B is a perspective view of the lysis module from which the integrated chip is separated.

In one embodiment of the present invention, the lysis module may include the integrated chip (100) in which the PCR chip and the syringe (120) described above are integrated, a plurality of heat transfer elements (210) spaced apart from each other to face each other and configured to transfer heat to the syringe (120) without being in contact with the syringe (120), the fixing portion (230) on which the integrated chip (100) is mounted and which fixes the cover portion (172) in a state in which the syringe (120) is sealed, and the first driving rail (270) configured to move the fixing portion (230) such that the syringe (120) receives the heat and guide the movement of the fixing portion (230).

The lysis module (200) of the present invention may perform the lysis process by transferring the heat from the heat transfer elements (210) to the sample solution injected into the syringe (120).

According to one embodiment of the present invention, the heat transfer elements (210) are spaced apart from each other to face each other and may transfer the heat without being in contact with the syringe (120). In the related art, for lysis work using enzymes, it is essential to provide an appropriate level of temperature for rapid activation of the enzymes. In order to transfer heat quickly and effectively, in the existing method, a method in which a heating element is in direct contact with a container containing enzymes or the like to transfer heat energy was used. However, this method has a disadvantage that the shape of the container or the like is limited for ease of contact, limited heat energy is transferred when contact is made unevenly, or the action for the contact process itself causes breakage or deformation of the container. Therefore, in order to overcome the above-mentioned disadvantages, the heat transfer element (210) of the present invention uses a non-contact method rather than a direct contact method with the syringe (120).

In one embodiment of the present invention, there may be a plurality of heat transfer elements (210), and the plurality of heat transfer elements (210) may be disposed at the same height as the syringe (120) when the integrated chip (100) is mounted on the fixing portion (230). Additionally, based on the position of the syringe (120), the plurality of heat transfer elements (210) may move close to or away from the syringe (120). A control unit may adjust the distance between the plurality of heat transfer elements (210) and the syringe (120) to adjust the temperature required for the lysis process. The present invention has an advantage that a movement path between processes is minimized by arranging a plurality of heat sources in a straight line, and thus the lysis process and the PCR can be successively performed and the process time can be shortened.

In one embodiment of the present invention, the heat transfer element (210) may be a halogen lamp.

In a case where the target temperature is set to 95° C. using a halogen heater and a general heat block, when the actual temperature inside the lysis syringe is measured, the temperature increase rate of the halogen heater is lower than that of a general heat block until around 80° C., but the time for the temperature to increase to 90° C. is the same. In addition, when the temperature of the syringe which can be maintained after 170 seconds is measured, it can be confirmed that in a case where a halogen heater is used, 95° C. can be steadily maintained after 170 seconds, but in a case where a general heat block is used, the temperature cannot rise any further and is maintained at 92° C.

Referring to these results, it can be seen that a halogen heater is more efficient than a general heat block to steadily maintain 95° C., which is the appropriate temperature for lysing the sample solution.

In addition, general heat blocks used in the related art mainly transfer heat energy through conduction, but the heat transfer element (210) of the present invention adopts a non-contact method using a halogen heater, and thus it is possible to overcome the disadvantages described above and it is possible to change the appearance of the syringe (120) to suit the purpose of an experiment. That is, there is no limitation on the form of the syringe (120).

The distance between the halogen heater of the present invention and the syringe (120) may be adjusted by the control unit. Selective heating may be performed by adjusting the distance to adjust the location and size of the focus of light. Additionally, a plurality of halogen heaters may be used to create a portion where light sources of the corresponding heaters are focused at the same time. That is, by heating only a specific portion of the syringe (120), the temperature of the specific portion may be selectively raised to generate convection due to a difference in heat energy within the syringe (120). By causing convection, the lysis process that destroys cells, bacteria, and viruses can be performed more efficiently and quickly.

In one embodiment of the present invention, the fixing portion (230) may provide a space in which the integrated chip (100) is stably mounted and transmit movement by the first driving rail (270) to the integrated chip (100). Specifically, the fixing portion (230) may serve to fix the integrated chip (100) such that the integrated chip (100 does not shake when the integrated chip (100) is moved by the first driving rail (270) between a position between the plurality of heat transfer elements (210) and a first position between a plurality of first heat blocks and a second position between a plurality of second heat blocks of a PCR module (300), which will be described below. When the lysis process and the nucleic acid amplification reaction are performed, since the integrated chip (100) is repeatedly moved between the first position and the second position dozens of times, the inner wall of the fixing portion (230) of the present invention may have a shape and a structure for being fixed to the outer wall of the integrated chip (100) such that the integrated chip (100) is not separated from the fixing portion (230). In addition, the fixing portion (230) serves to firmly fix the integrated chip (100) even during the lysis process or when the sample solution is moved to the PCR chip.

In addition, the inner wall of the fixing portion (230) may have a shape and a structure for being fixed to the outer wall of the cover portion (172) when the cover portion (172) hinge-coupled to both upper sides of the integrated chip (100 or the valve portion (180) seals the upper end of the syringe (120). The integrated chip (100) is mounted on the fixing portion (230), and the fixing portion (230) positions and fixes the cover portion (172) at the upper end of the syringe (120) such that the cap (173) seals the upper end of the syringe (120).

In one embodiment of the present invention, the lysis module (200) may include the first driving rail (270) that moves the fixing portion (230) so that the syringe (120) receives heat and guides the movement of the fixing portion (230). The first driving rail (270) may serve to move the fixing portion (230) on which the integrated chip (100) is mounted. The fixing portion (230) may be positioned between the plurality of heat transfer elements (210) and may be moved such that a valve adjustment bar (290) and the valve portion (180) of the integrated chip (100) come into contact with each other by the first driving rail (270).

Additionally, the first driving rail (270) may include any means that enables the fixing portion (230 on which the PCR chip (10) is mounted to be moved between the first heat blocks (310 and 310′) and between the second heat blocks (330 and 330′). Specifically, as the first driving rail (270) moves the fixing portion (230) from the first position to the second position, the PCR chip (10) mounted on the fixing portion (230) may be sequentially brought into contact with the first heat blocks (310 and 310′ and the second heat blocks (330 and 330′) at each position. For example, the first driving rail (270) may include a horizontally extending rail and a movable part (not shown) constituted by a motor member for moving the fixing portion (230) through the rail, but is not limited thereto.

FIG. 7 is a cross-sectional view of the device according to the embodiment of the present invention as seen from above. Referring to FIG. 7, in one embodiment of the present invention, the first driving rail (270) may extend to the first position between the plurality of first heat blocks and the second position between the plurality of second heat blocks, which will be described below. The first driving rail (270) may move the fixing portion (230) on which the integrated chip (100) is mounted from the first position to the second position and repeatedly move the fixing portion (230) between the first position and the second position dozens of times to perform a nucleic acid amplification reaction. Since the first driving rail (270) extends, the lysis module (200) and the PCR module (300) may be organically combined in one device, and the lysis reaction and the nucleic acid amplification reaction may be sequentially performed in one device.

In one embodiment of the present invention, the lysis module (200) may further include a pressing protrusion (250). The pressing protrusion (250) may serve to press the cap (173) inserted into the cover portion (172) downward such that the sample solution is moved to the PCR chip (10) by pressure after being lysed.

The first driving rail (270) positions the fixing portion (230) on which the integrated chip (100) is mounted between the plurality of heat transfer elements (210) to start the lysis process. The pressing protrusion (250) may be spaced apart from the upper side of the fixing portion (230) to correspond to the position of the cap (173). The pressing protrusion (250) spaced apart from the upper side of the fixing portion (230) may move toward the cap (173) inserted into the cover portion (172). Additionally, the number of pressing protrusions (250 can be set to correspond to the number of syringes (120).

In one embodiment of the present invention, the present invention has an advantage that the flow of fluid can be controlled in one direction without reverse flow by the pressing protrusion (250). When the pressing protrusion (250) moves downward, the sample solution moves to the PCR chip (10), thereby preparing to start the PCR. That is, after the lysis process in the lysis module (200) is completed, the user may directly adjust the pressing protrusion (250) to proceed with the PCR process, or the operation of the pressing protrusion (250) may be automatically set by the control unit.

In one embodiment of the present invention, the lysis module (200) may further include a valve adjustment bar (290). The valve adjustment bar (290) serves to press and slide the valve portion (180) in a direction opposite to a moving direction of the fixing portion (230). That is, when the valve portion (180) is moved a certain distance by the valve adjustment bar (290), the flow path (170) connected to the receiving portion 164 and the reaction channel of the PCR chip (10) may be opened.

The valve adjustment bar (290) may be located between the heat transfer element (210) and the first heat block of the PCR module (300). Additionally, the valve adjustment bar (290 may be disposed at the same height as the valve portion (180) in a state in which the integrated chip (100) is mounted on the fixing portion (230). Since the valve portion (180) serves to perform a preparation process for starting the PCR as described above, the valve portion (180) is preferably located between the heat transfer element (210) and the first heat block.

The valve adjustment bar (290) may be operated by the control unit. The valve adjustment bar (290) may move in the same direction as second driving rails, which will be described below. That is, the second driving rails (370, 370′, 380, and 380′) may move the heat blocks (310, 310′, 330, and 330′) toward the PCR chip (10) such that the heat blocks (310, 310′, 330, and 330′) come into contact with the PCR chip (10) or move the heat blocks (310, 310′, 330, and 330′ away from the PCR chip (10) in order to move the PCR chip (10. Likewise, the valve adjustment bar (290) may also be moved toward the valve portion (180) (or the integrated chip (100)) to come into contact with the valve portion (180 or moved away from the valve portion (180) to allow the fixing portion (230) to move.

When the first driving rail (270) moves the fixing portion (230) on which the integrated chip (100) is mounted to a position adjacent to the valve adjustment bar (290 after the lysis process is completed, the valve adjustment bar (290) is also moved toward the valve portion (180) (or the integrated chip (100)) to come into contact with the valve portion (180). When the fixing portion (230) is moved to a position corresponding to the valve adjustment bar (290), the valve adjustment bar (290) comes into contact with one side of the valve portion (180) to press and slide the valve portion (180) in a direction opposite to the moving direction of the fixing portion (230).

When the sample solution (or the nucleic acid) in moved to the PCR chip (10) by the sliding movement of the valve portion (180), the first driving rail (270) may again move the fixing portion (230) on which the integrated chip (100) is mounted to a position corresponding to the valve adjustment bar (290). In this case, the valve adjustment bar (290) comes into contact with one (the other) side of the valve portion (180) to press and slide the valve portion (180) in a direction opposite to the moving direction of the fixing portion (230), and the inlet of the reaction channel of the PCR chip (10) may be sealed. After the above process by the valve portion (180) is completed, the PCR may start.

The valve adjustment bar (290) of the present invention has an advantage that the valve portion (180) can be operated by a simple movement of the valve adjustment bar (290) and the fixing portion (230), which can reduce the amount of power consumed to control the valve, and thus the present device can be used for on-site diagnosis.

The PCR module (300) refers to a module used in PCR to amplify nucleic acids having a specific base sequence. For example, the module may perform a denaturing step of heating a sample solution containing double-stranded DNA to a specific temperature, for example, about 95° C., to separate the double-stranded DNA into single-stranded DNA, an annealing step of providing an oligonucleotide primer having a sequence complementary to a specific base sequence to be amplified to the sample solution and cooling the primer along with the separated single stranded DNA to a specific temperature, for example, 55° C., to bind the primer to the specific base sequence of the single strand of DNA and to form a partial DNA-primer complex, and an extension (or amplification) step of forming double-stranded DNA using a DNA polymerase based on the primer of the partial DNA-primer complex while maintaining the sample solution at an appropriate temperature, for example, 72° C., after the annealing step, and this process is repeated, for example, 20 to 40 times, and thus DNA having a specific base sequence can be amplified exponentially.

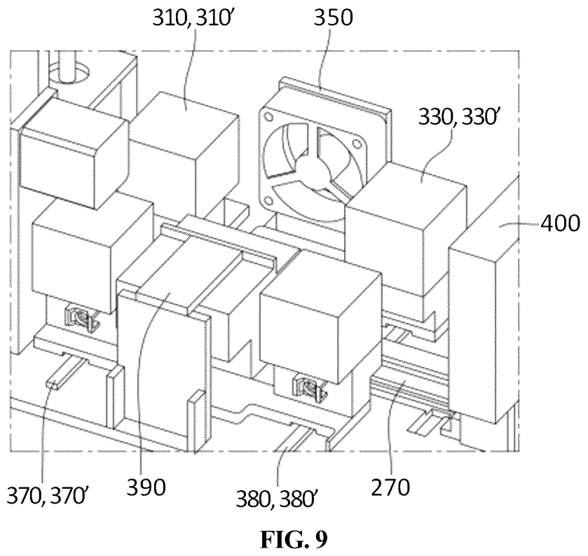

FIG. 9 is a perspective view of a PCR module according to an embodiment of the present invention.

Referring to FIG. 9, a PCR module (300) may include a plurality of first heat blocks (310 and 310′) spaced apart from each other to face each other around the first position, a plurality of second heat blocks (330 and 330′) spaced apart from each other to face each other around the second position, and second driving rails (370, 370′, 380, and 380′) for moving each of the plurality of first heat blocks and the plurality of second heat blocks toward the PCR chip (10). As described above, the first driving rail (270) of the lysis module extends from the first position to the second position, and the PCR chip (10) is reciprocated between the first position and the second position by the driving rail to perform the PCR.

The heat block may include a plurality of first heat blocks and a plurality of second heat blocks. Specifically, the plurality of first heat blocks may be disposed to be spaced apart from each other around the first position, and the plurality of second heat blocks may be disposed to be spaced apart from each other around the second position, which is different from the first position.

Additionally, each of the plurality of first heat blocks may move toward the first position or move outward from the first position, and similarly, each of the plurality of second heat blocks may also move toward the second position or outward from the second position. Here, the first position to the second position mean a path along which the PCR chip (10) moves, and through the movement of the first heat blocks and the second heat blocks as described above, the PCR chip (10) may sequentially come into thermal contact with the first heat blocks and the second heat blocks.

The first heat blocks (310 and 310′) and the second heat blocks (330 and 330′) are for maintaining the temperature for performing the denaturing step, the annealing step, and the extension (or amplification) step for amplifying nucleic acids, wherein the first heat blocks (310 and 310′) and the second heat blocks (330 and 330′) may provide the necessary temperature required for each step and may include various modules for maintaining this temperature or may be operably connected to such modules.

The first heat blocks (310 and 310′) and the second heat blocks (330 and 330′) may include a metal material, for example, copper or aluminum, or may be made of a copper or aluminum material for even heat distribution and rapid heat transfer over the same area, but the material is not limited thereto.

The first heat blocks may be implemented to maintain an appropriate temperature for performing the denaturing step or the annealing and extension (or amplification) steps.

For example, the first heat blocks may be maintained at 50° C. to 100° C. When the denaturing step is performed at the first heat blocks, the temperature may preferably be maintained at 90° C. to 100° C., and more preferably at 95° C. On the other hand, when the annealing and extension (or amplification) steps are performed at the first heat blocks 310 and 310′, the temperature may preferably be maintained at 55° C. to 75° C., and more preferably at 72° C.

Likewise, the second heat blocks (330 and 330′) may also be implemented to maintain an appropriate temperature for performing the denaturing step, or the annealing and extension (or amplification) steps. For example, the second heat blocks (330 and 330′) may be maintained at 50° C. to 100° C. When the denaturing step is performed at the second heat blocks (330 and 330′), the temperature may preferably be maintained at 90° C. to 100° C., and more preferably at 95° C. On the other hand, when the annealing and extension (or amplification) steps are performed at the second heat blocks (330 and 330′), the temperature may be preferably maintained at 55° C. to 75° C., and more preferably at 72° C.

In the temperature of the first heat blocks (310 and 310′) and the second heat blocks (330 and 330′), the temperature at which the denaturing step or the annealing and extension (or amplification) steps may be performed is not limited to the above, but the first heat blocks (310 and 310′) and the second heat blocks (330 and 330′) are preferably implemented to perform different steps and maintain different temperatures.

The first heat blocks (310 and 310′) and the second heat blocks (330 and 330′) may be spaced a predetermined distance from each other to prevent mutual heat exchange. Accordingly, since heat exchange does not occur between the first heat blocks (310 and 310′) and the second heat blocks (330 and 330′), in the nucleic acid amplification reaction that can be significantly affected by even slight temperature changes, accurate temperature control of the denaturing step and the annealing and extension (or amplification) steps is possible.

Referring to FIGS. 7 and 9, the second driving rails (370, 370′, 380, and 380′) are connected to the first heat blocks (310 and 310′) and the second heat blocks (330 and 330′), respectively, to move the heat blocks (310, 310′, 330, and 330′) simultaneously or individually. That is, the second driving rails (370, 370′, 380, and 380′) may move the heat blocks (310, 310′, 330, and 330′) toward the PCR chip (10) such that the heat blocks (310, 310′, 330, and 330′) come into contact with the PCR chip (10) or may move the heat blocks (310, 310′, 330, and 330′) away from the PCR chip (10) to allow the PCR chip (10) to move. The movements of the heat blocks by the second driving rails are indicated by arrows shown in FIG. 7. The first heat blocks (310 and 310′) and the second heat blocks (330 and 330′) sequentially come into thermal contact with the PCR chip (10) by the second driving rails (370, 370′, 380, and 380′), and thus the PCR may be performed. For example, the second driving rails (370, 370′, 380, and 380′) are implemented for each of the heat blocks (310, 310′, 330, and 330′) to guide movement paths of the heat blocks (310, 310′, 330, and 330′). Additionally, he second driving rails may include a movable part constituted by a motor member for moving the heat block on the second driving rail, but is not limited thereto.

Referring to FIGS. 7 and 9, according to one embodiment of the present invention, the present device may further include an optical measurement unit (390). The optical measurement unit includes a light source and a detection portion.

The light source is located between the heat blocks to emit light toward the PCR chip (10). The light source may be selected from the group consisting of a mercury arc lamp, a xenon arc lamp, a tungsten arc lamp, a metal halide arc lamp, a metal halide fiber, a light emitting diode (LED), and a photodiode. Additionally, the wavelength of the light source may be selected within the range of about 200 nanometers (nm) to 1300 nanometers (nm), and may be implemented as multiple wavelengths using multiple light sources or filters.

The detection portion is for detecting light emitted from the light source and may be selected from the group consisting of a charge-coupled device (CCD), a charge injection device (CID), a complementary-metal-oxide-semiconductor detector (CMOS), and a photo multiplier tube (PMT).

The light source and the detection portion may be disposed between the heat blocks, or the detection portion may be disposed opposite to the light source. Through this, it is possible to measure and analyze the PCR in real time, even while the PCR chip (10) performs the PCR as the PCR chip (10) reciprocates between the first heat blocks (310 and 310′) and the second heat blocks (330 and 330′).

In this case, a separate fluorescent material may be added to the sample solution included in the PCR chip (10), and the fluorescent material emits light with a specific wavelength according to the generation of the PCR product to cause an optical signal that may be measured and analyzed.

Referring to FIGS. 6, 7, and 9, in one embodiment of the present invention, the present device may include a control unit to control the moving directions of the heat transfer element (210), the heat blocks, the first driving rail (270), and the second driving rails (370, 370′, 380, and 380′), and the valve adjustment bar (290), a cooling unit (350) located between the first position and the second position to quickly lower the temperature of the PCR chip (10), and a power unit (400) that supplies power to the control unit and the cooling unit (350) to enable on-site diagnosis.

In one embodiment of the present invention, the control unit (not shown) may adjust the movements of the heat transfer element (210), the heat blocks, the first driving rail (270), the second driving rails (370, 370′, 380, and 380′), and the valve adjustment bar (290) in the device. Specifically, the control unit may operate the first driving rail (270) and the second driving rails (370, 370′, 380, and 380′) to adjust the plurality of heat blocks such that the plurality of heat blocks move close to or away from the integrated chip (100) during the lysis process and the PCR. The control unit may adjust the location and size of the focus by moving the plurality of heat transfer elements (210), and may move the valve portion (180) of the integrated chip (100) by operating the valve adjustment bar (290).

In one embodiment of the present invention, the cooling unit (350) may cool a PCR processing target material heated by the heat blocks. A plurality of cooling units (350) may be provided to correspond to each of the heat blocks, and the number of the cooling units may be less than the number of heating units. The cooling unit (350) is located between the first heat blocks (310 and 310′) and the second heat blocks and may cool the PCR processing target material and the PCR chip (10) heated by the first heat blocks during the movement of the PCR chip from the first heat blocks to the second heat blocks. For example, the cooling unit (350) may include a fan.

The first driving rail (270) positions the fixing portion (230) in front of the cooling unit (350) for a predetermined time such that the PCR chip is cooled for the predetermined time, or the PCR chip may be temporarily cooled by the cooling unit (350) while the fixing portion (230) is in the process of being moved to the second heat block. In this way, by arranging the cooling unit (350) in the path where the PCR chip is transferred from the first heat block to the second heat block, the temperature decrease rate of the PCR processing target material can be improved and the process time can be shortened as a result.

In one embodiment of the present invention, the power unit (400) may use a lithium-ion battery. Power can be supplied to the device without a separate external power supply. Accordingly, there is an advantage that on-site diagnosis is possible using this device.

Hereinafter, a lysis and nucleic acid amplification method using the integrated chip (100), the plunger (110), the lysis module (200), and the device of the present invention will be described.

The lysis process using the integrated chip (100) and the lysis module (200) is described as follows.

The sample solution to be lysed and lysis buffer may be injected into the syringe (120). The syringe (120) is coupled to the insertion portion (160) of the integrated chip (100). The insertion portion (160) is constituted by the coupling portion (162) and the receiving portion (164), and the coupling portion (162) and the lower end of the syringe (120) are respectively provided with a coupling groove and a coupling protrusion, and thus fitting-coupling is possible. After the lower end of the syringe (120) is coupled to the coupling portion (162), the cover portion (172) may be rotated and positioned on the upper end of the syringe (120). Both ends of the cover portion (172) are hinge-coupled to both sides of the insertion portion (160) to adjust the rotation angle. The cover portion (172) may serve to support the upper end of the syringe (120) and include a groove with open upper and lower surfaces in a portion of the cover portion (172), and the cap (173) capable of sealing the upper surface of the syringe (120) can be inserted into the groove.

The integrated chip (100) may be mounted on the fixing portion (230) of the lysis module (200). The fixing portion (230) may be moved by the first driving rail (270) such that heat may be transferred to the integrated chip (100) mounted on the fixing portion (230) by the plurality of heat transfer elements (210), and thus the syringe (120) may be positioned between the plurality of heat transfer elements (210). Thereafter, the radiant heat of the heat transfer elements (210) may be transferred to the syringe (120) to perform the lysis process.

The process of starting the PCR after the lysis process is completed is described as follows.

After the lysis process is completed in the lysis module (200), the valve portion (180) is pressed through the valve adjustment bar (290) in a direction opposite to the moving direction of the fixing portion (230) to open the reaction channel. Specifically, the first driving rail (270) may move the fixing portion (230) to be adjacent to the position of the valve adjustment bar The valve adjustment bar (290) may be located at the same height as the valve portion (180) included in the integrated chip (100). The first driving rail (270) brings the valve portion (180) and the valve adjustment bar (290) into contact with each other to slide the valve portion (180). The flow path (170) of the integrated chip (100) may be opened by the valve portion (180). The cap (173) may be pressed downward through the pressing protrusion (250) such that all of the sample solution contained in the receiving portion (164) may be moved to the PCR chip. By applying an external force, all of the lysed sample solution may be moved to the PCR chip. After all of the sample solution is moved to the PCR chip, the valve portion (180) is pressed with the valve adjustment bar (290) in the direction opposite to the moving direction of the fixing portion (230) to close the reaction channel and start the PCR.

The nucleic acid amplification process (PCR) using the device is described in detail as follows.

The first heat blocks (310 and 310′) may be heated and maintained at a temperature for the denaturing step, for example, 90° C. to 100° C., preferably 95° C. The second heat blocks (330 and 330′) may be heated and maintained at a temperature for the annealing and extension (or amplification) steps, for example, 55° C. to 75° C., preferably 72° C.

Subsequently, the first driving rail (270) may move the fixing portion (230) to the first position. Accordingly, when the PCR chip (10) is located at the first position, the first heat blocks (310 and 310′) spaced apart from each other to face each other around the first position may be moved toward the PCR chip 10 by the second driving rails (370, 370′, 380, and 380′) to come into thermal contact with the PCR chip (10). Accordingly, a first denaturing step of PCR may be performed.

Subsequently, the second driving rails (370, 370′, 380, and 380′) may move the first heat blocks (310 and 310′) away from the PCR chip (10). When the contact with the first heat blocks (310 and 310′) is released through this, the first denaturing step of PCR is completed, and the first driving rail (270) may move the PCR chip (10) to the second position.

The second driving rails (370, 370′, 380, and 380′) may move the second heat blocks (330 and 330′), which are spaced apart from each other to face each other around the second position, toward the PCR chip (10). As a result, when the second heat blocks (330 and 330′) and the PCR chip (10) are in thermal contact with each other, first annealing and extension (or amplification) steps of PCR may be performed.

Finally, when the second heat blocks (330 and 330′) and the PCR chip (10) are separated from each other through the second driving rails (370, 370′, 380, and 380′), the first annealing and extension (or amplification) steps of PCR are completed, and thus the PCR of a first cycle may be completed. Such a PCR may be performed multiple times.

In this way, in the present invention, the PCR chip (10) sequentially comes into thermal contact with the first heat blocks (310 and 310′) and the second heat blocks (330 and 330′), and thus the PCR may be performed. At this time, a plurality of first heat blocks (310 and 310′) are implemented, and similarly, a plurality of second heat blocks (330 and 330′) are also implemented, and thus both sides of the PCR chip (10) may be brought into thermal contact with the heat blocks (310, 310′, 330, and 330′).

That is, unlike the existing case where only one side of the PCR chip (10) was in thermal contact, both sides of the PCR chip (10) are in thermal contact with the heat blocks (310, 310′, 330, and 330′), thereby improving thermal efficiency and further improving PCR speed and efficiency.

As described above, in the drawings and specification, optimal embodiments are disclosed. Here, specific terms are used, but this is only used for the purpose of describing the present application and is not used to limit the meaning or the scope of the present application described in the claims. Therefore, it should be understood by those of ordinary skill in the art that various modifications and equivalents can be made from the embodiments of the present application. Thus, the true technical scope should be determined by the technical spirit of the appended claims.

1. A plunger that is inserted into a syringe and moves a solution while reciprocating, comprising a porous sintered polymer filter layer configured to swell upon contact with a solution to block movements of the solution and air.

2. The plunger according to claim 1,
wherein, when the polymer filter layer comes into contact with the solution in the syringe, the plunger pushes the solution to an outlet of the syringe as the plunger moves.

3. The plunger according to claim 1,
wherein the polymer filter layer is located on a passage that passes vertically through an inside of the plunger.

4. The plunger according to claim 1,
wherein the polymer includes one or more selected from the group consisting of ultra-high molecular weight polyethylene (UHMW-PE), hydroxypropylmethylcellulose, hydroxyethylmethylcellulose, hydroxypropylcellulose, hydroxymethylcellulose, hydroxyethylcellulose, carboxymethylcellulose, calcium carboxymethylcellulose, sodium carboxymethylcellulose, methylcellulose, ethylcellulose, polyethylene oxide, locust bean gum, guar gum, xanthan gum, acacia gum, tragacanth gum, alginic acid, sodium alginate, calcium alginate, ammonium alginate, agar, gelatin, poloxamer, poly(methyl methacrylate), carbomer, polycarbophil, polyvinylpyrrolidone, polyvinyl acetate, polyethylene glycol, polyvinylpyrrolidone-polyvinyl acrylate copolymer, polyvinyl alcohol-polyethylene glycol copolymer, polyvinylpyrrolidone-polyvinyl acetate copolymer, bentonite, hectorite, carrageenan, ceratonia, cetostearyl alcohol, chitosan, hydroxypropyl starch, magnesium aluminum silicate, polydextrose, poly(methyl vinyl ether/maleic anhydride), propylene glycol alginate, saponite, and polycarbophil.

5. The plunger according to claim 1,
wherein the polymer is a bead with a diameter of 10 μm to 800 μm.

6. The plunger according to claim 1,
further comprising a porous barrier filter layer in contact with one surface or the other surface of at least one layer of the polymer filter layer.

7. The plunger according to claim 6,
wherein the barrier filter layer includes polyethylene.

8. A solution-moving module comprising:
the plunger according to claim 1; and
a syringe into which the plunger is inserted.

9. The solution-moving module according to claim 8,
further comprising a pushing portion configured to come into contact with at least one portion of the plunger to move the plunger,
wherein the pushing portion extends in a direction perpendicular to an end portion of the plunger.

10. The solution-moving module according to claim 9,
wherein an upper portion of the plunger has a shape including convex portions and concave portions such that an end portion of the pushing portion comes into contact with the convex portions of the plunger.

11. The solution-moving module according to claim 9,
wherein the pushing portion includes a protrusion configured to come into contact with at least a part of a surface of the plunger at a lower portion thereof, and includes a passage through which air passes at a side portion thereof.

12. The solution-moving module according to claim 8,
wherein the plunger includes a packing member in contact with an inner wall of the syringe.

13. The solution-moving module according to claim 8,
wherein the syringe includes a hydrophobic membrane located below a region containing the solution.

14. The solution-moving module according to claim 13,
wherein the membrane includes one or more of a filter portion and a porous support portion, and
the solution passes through the membrane when pressure is applied.

15. The solution-moving module according to claim 14,
wherein the plunger has a tapered shape with a cross-sectional diameter that decreases toward a bottom thereof.

16. The solution-moving module according to claim 15,
wherein the syringe further includes a plunger support portion located above the membrane, and
the plunger support portion has a shape that is to be combined with the plunger when the plunger moves to the bottom of the syringe.

17. The solution-moving module according to claim 16,
wherein the syringe further includes a membrane support portion located below the membrane and having a flow path for the solution.

18. The solution-moving module according to claim 16,
wherein the plunger support portion includes a packing member in contact with an inner wall of the syringe.

19. An integrated chip including the solution-moving module according to claim 8, comprising:
a polymerase chain reaction (PCR) chip including an inlet, an outlet, and a reaction channel;
one or more insertion portions which extend in a longitudinal direction of the reaction channel on one side of the PCR chip and to which the syringe with an open upper end is detachably attached;
a cover portion including a cover plate for opening or closing the upper end of the syringe and a pair of support plates connected to both ends of the cover plate; and
a valve portion which is disposed between the insertion portion and the PCR chip, adjusts opening or closing of the reaction channel, and seals the inlet of the reaction channel during a PCR,
wherein a sample solution is sequentially moved to the PCR chip after being lysed in the syringe.

20. The integrated chip according to claim 19,
wherein, in the integrated chip, a cap made of a soft material for sealing the upper end of the syringe is inserted into the cover portion to seal the upper end of the syringe, and
the integrated chip further includes a pressing protrusion configured to press the cap downward such that the sample solution is moved to the PCR chip by pressure after being lysed.

21. A lysis module comprising:
the integrated chip according to claim 19;
a plurality of heat transfer elements spaced apart from each other to face each other and configured to transfer heat to the syringe;
a fixing portion on which the integrated chip is mounted and which fixes the cover portion in a state in which the syringe is sealed; and
a driving rail configured to move the fixing portion such that the syringe receives the heat and configured to guide a movement of the fixing portion,
wherein the sample solution injected into the syringe is lysed by the heat of the heat transfer elements.

22. An on-site diagnostic device comprising:
the lysis module according to claim 21; and
a PCR module in which a PCR is performed,
wherein the lysis and the PCR are successively performed.
